(19) United States
(12) Patent Application Publication
(10) Pub. No.: US 2026/0301996 A1
(43) Pub. Date: Oct. 1, 2026

(54) COAXIAL CABLE AND MULTICORE CABLE

(71) Applicant: SUMITOMO ELECTRIC INDUSTRIES, LTD., Osaka (JP)

(72) Inventor: Yuto KOBAYASHI, Tochigi (JP)

(21) Appl. No.: 19/559,107

(22) Filed: Mar. 6, 2026

(30) Foreign Application Priority Data
Mar. 28, 2025 (JP) 2025-055535

(51) Int. Cl. H01B 11/20; H01B 11/18

(52) U.S. Cl. CPC H01B 11/20; H01B 11/183

(57) ABSTRACT

A coaxial cable includes a conductor, an insulator disposed outside the conductor, and a first shield layer disposed outside the insulator. The first shield layer includes a metal foil disposed spirally or longitudinally along a longitudinal direction of the insulator.

### CROSS REFERENCE TO RELATED APPLICATIONS

This application claims priority based on Japanese Patent Application No. 2025-055535 filed on Mar. 28, 2025, and the entire contents of the Japanese patent application are incorporated herein by reference.

### TECHNICAL FIELD

The present disclosure relates to a coaxial cable and a multicore cable.

### BACKGROUND

Patent literature (Japanese Unexamined Patent Application Publication No. 2022-003613) discloses a coaxial cable, including a conductor, an electrically insulating member provided over a periphery of the conductor, a shielding layer in which a served shield including a plurality of metal wires is helically wrapped around a periphery of the electrically insulating member, and a sheath provided over a periphery of the shielding layer. The electrically insulating member includes indentations on portions of a surface of the electrically insulating member to be brought into contact with the plurality of metal wires respectively. The indentations on the electrically insulating member are mated to the plurality of metal wires respectively. The shielding layer is configured in such a manner that portions in respective circumferential directions of the plurality of metal wires being brought into contact with the electrically insulating member are mated to the indentations, respectively, on the electrically insulating member, and adjacent ones of the plurality of metal wires in a circumferential direction of the shielding layer are brought into surface contact with each other.

### SUMMARY

A coaxial cable of the present disclosure includes a conductor, an insulator disposed outside the conductor, and a first shield layer disposed outside the insulator. The first shield layer includes a metal foil disposed spirally or longitudinally along a longitudinal direction of the insulator.

### BRIEF DESCRIPTION OF THE DRAWINGS

FIG. 1 is a cross-sectional view of a coaxial cable in a plane perpendicular to a longitudinal direction according to an embodiment of the present disclosure.

FIG. 2 is a cross-sectional view of a conventional coaxial cable in a plane perpendicular to a longitudinal direction.

FIG. 3 is a cross-sectional view of a coaxial cable in a plane perpendicular to a longitudinal direction according to an embodiment of the present disclosure.

FIG. 4 is a cross-sectional view of a coaxial cable in a plane perpendicular to a longitudinal direction according to an embodiment of the present disclosure.

FIG. 5 is a cross-sectional view of a coaxial cable in a plane perpendicular to a longitudinal direction according to an embodiment of the present disclosure.

FIG. 6A is a cross-sectional view of a metal tape in a plane perpendicular to a longitudinal direction.

FIG. 6B is a cross-sectional view of a base-material-attached metal tape in a plane perpendicular to a longitudinal direction.

FIG. 7 is a cross-sectional view of a multicore cable in a plane perpendicular to a longitudinal direction according to an embodiment of the present disclosure.

FIG. 8 shows an evaluation result of an experimental example 1-1.

FIG. 9 shows an evaluation result of an experimental example 1-2.

FIG. 10 shows an evaluation result of an experimental example 1-3.

FIG. 11 is a table showing evaluation results of experimental examples 2-1 to 2-6.

### DETAILED DESCRIPTION

Conventionally, a coaxial cable having a shield with a spirally wound structure has been used in various applications.

In recent years, there has been a demand for further improvement in electrical characteristics of the coaxial cable, and for example, there has been a demand for a coaxial cable having excellent insertion loss.

An object of the present disclosure is to provide a coaxial cable having excellent insertion loss.

According to the present disclosure, a coaxial cable having excellent insertion loss can be provided.

Embodiments will be described below.

### Description of Embodiments of Present Disclosure

First, embodiments of the present disclosure will be listed and described. In the following description, the same or corresponding elements are denoted by the same reference numerals, and the same description thereof will not be repeated.

(1) A coaxial cable according to one aspect of the present disclosure includes a conductor, an insulator disposed outside the conductor, and a first shield layer disposed outside the insulator. The first shield layer includes a metal foil disposed spirally or longitudinally along a longitudinal direction of the insulator.

In a conventional coaxial cable, a shield in which a metal element wire was arranged in a spirally wound structure was used as the shield layer. However, in the case of the shield having the spirally wound structure, current flows spirally along a longitudinal direction of the metal element wire, and a surface of the shield layer, such as a surface facing the insulator, includes unevenness derived from the shape of the metal element wire. Thus, a distance between the conductor and the shield layer is not constant, which affects insertion loss.

In contrast, since the coaxial cable has the first shield layer including the metal foil disposed spirally or longitudinally along the longitudinal direction of the insulator, current flows along the longitudinal direction of the coaxial cable, the unevenness of the surface of the first shield layer can be reduced, and the surface can be smoothed. Thus, a coaxial cable having excellent insertion loss can be obtained.

(2) In (1), the metal foil may have an elongation at break of 5% or more.

By setting the elongation at break of the metal foil to 5% or more, occurrence of breakage of the metal foil is suppressed when the coaxial cable is manufactured, and productivity and yield can be improved. In addition, by setting the elongation at break of the metal foil to 5% or more, the first shield layer can be prevented from being damaged even when the coaxial cable is repeatedly bent.

(3) In (1) or (2), the first shield layer may consist only of the metal foil.

By forming the first shield layer only of the metal foil, the coaxial cable having particularly excellent insertion loss can be obtained.

(4) In any one of (1) to (3), the metal foil may include copper.

By using copper as the metal foil of the first shield layer, workability in manufacturing of the coaxial cable is improved, and the coaxial cable having excellent insertion loss can be obtained.

(5) The coaxial cable according to any one of (1) to (4) may further include a second shield layer outside the first shield layer. The second shield layer may include a metal tape with a base material, the metal tape including a metal layer disposed on the base material, and the metal tape being disposed spirally along the longitudinal direction of the insulator.

The coaxial cable according to one aspect of the present disclosure further includes the second shield layer, and thus, it is possible to particularly reduce signal leakage to the outside and radio wave intrusion from the outside, and to improve noise characteristics.

(6) The coaxial cable according to (5) may further include an outer sheath outside the second shield layer.

Since the coaxial cable of the present disclosure further includes the outer sheath, the inside members surrounded by the outer sheath are protected, and durability of the coaxial cable can be improved.

(7) The coaxial cable according to any one of (1) to (4) may further include an outer sheath outside the first shield layer.

Since the coaxial cable of the present disclosure further includes the outer sheath, the inside members surrounded by the outer sheath are protected, and the durability of the coaxial cable can be improved.

(8) In (6) or (7), the outer sheath may include one or more materials selected from a polyester resin, a fluororesin, and a polyolefin resin.

The outer sheath includes one or more materials selected from a polyester resin, a fluororesin, and a polyolefin resin, and thus flexibility and durability of the coaxial cable can be improved.

(9) A multicore cable according to an aspect of the present disclosure includes a core formed by twisting a plurality of coaxial cables, and a sheath disposed outside the core. The plurality of coaxial cables include at least one coaxial cable of any one of (1) to (8).

According to the multicore cable according to one aspect of the present disclosure, since the coaxial cable according to one aspect of the present disclosure is included, the multicore cable having excellent insertion loss can be obtained.

(10) The multicore cable according to (9) may further include an outer shield layer between the core and the sheath.

The multicore cable according to one aspect of the present disclosure includes the outer shield layer, and thus, it is possible to particularly reduce signal leakage to the outside and radio wave intrusion from the outside, and to improve noise characteristics.

### Details of Embodiments of Present Disclosure

Specific examples of a coaxial cable and a multicore cable according to an embodiment of the present disclosure (hereinafter referred to as "the present embodiment") will be described below with reference to the drawings. The present invention is not limited to these examples, and is indicated by the scope of the claims, and is intended to include all modifications within the meaning and scope equivalent to the scope of the claims.

In the present specification, the names of members may be described with first, second, and the like added thereto. For example, the term "first shield layer" and the term "second shield layer" are used. The first and second added to the shield layer are merely used to identify each member and prevent confusion during the description, and do not represent the arrangement and priority order. When there is no possibility of confusion and when they are collectively referred to, they can be denoted as a shield layer.

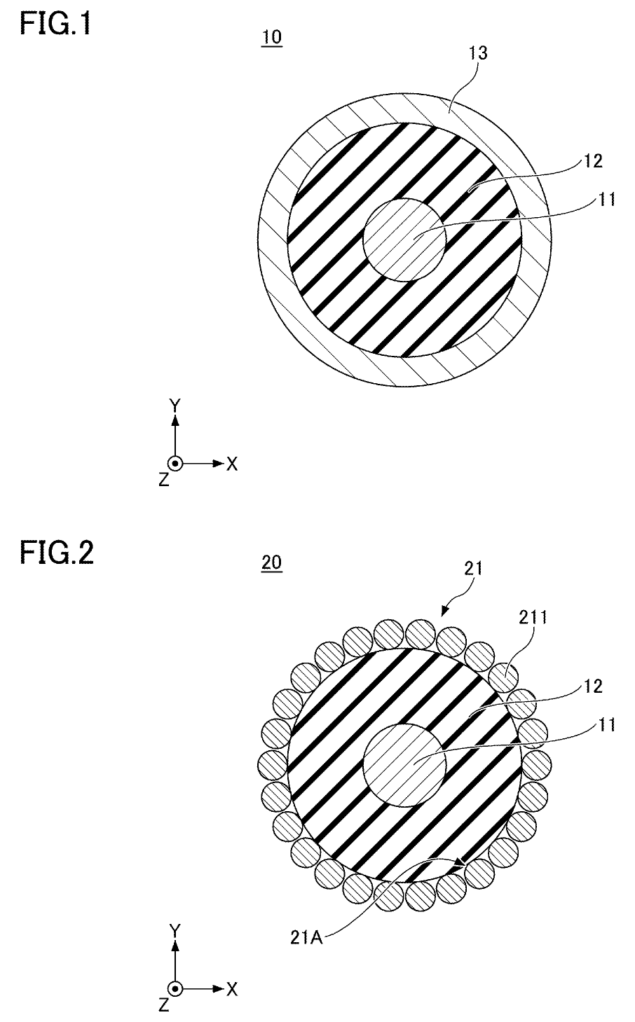

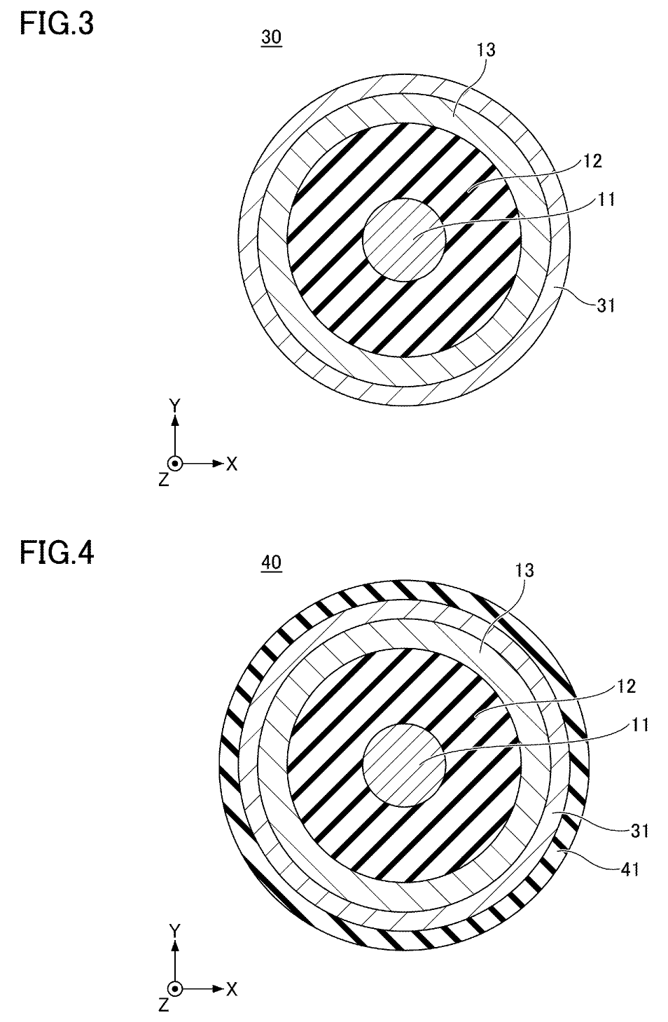

FIGS. 1, 2, 3, 4, 5, 6A, 6B, and 7 are schematic views for explaining the arrangement of the respective members, and the like, and do not accurately show the sizes, shapes, or the like of the respective members. In FIGS. 1-5 and 7, a Z axis is an axis along a longitudinal direction of a coaxial cable or a multicore cable, and an XY plane is a plane perpendicular to the longitudinal direction of the coaxial cable or the multicore cable. FIG. 2 is an explanatory view of a conventional coaxial cable, and FIGS. 3-5 are modifications of the coaxial cable of the present embodiment. Thus, the coaxial cable will be described mainly with reference to FIG. 1, and will be described with reference to FIGS. 2-5 as necessary.

### Coaxial Cable

A cross-sectional view perpendicular to a longitudinal direction of a coaxial cable 10 of the present embodiment is shown in FIG. 1.

As shown in FIG. 1, the coaxial cable 10 of the present embodiment includes a conductor 11, an insulator 12 disposed outside the conductor 11, and a first shield layer 13 disposed outside the insulator 12.

Hereinafter, each member of the coaxial cable 10 of the present embodiment will be described.

### (1) Members Included in Coaxial Cable

### 1-1 Conductor

The conductor 11 is shown as a single circle in FIG. 1. However, since FIG. 1 is a schematic view, the conductor 11 is not limited to such a form. The conductor 11 may be any of a solid conductor, which is a single conductive wire, a twisted wire formed of a plurality of conductor element wires twisted together, and a compressed conductor formed by compressing a twisted wire.

As the material of the conductor 11, for example, one or more conductor materials selected from a copper alloy, copper, silver-plated soft copper, and tin-plated soft copper may be used. Soft copper may be used as the copper.

### 1-2 Insulator

The insulator 12 may include a resin material.

As the resin material, for example, one or more materials selected from fluororesins such as polytetrafluoroethylene (PTFE), tetrafluoroethylene-perfluoroalkyl vinyl ether copolymer (PFA), tetrafluoroethylene-hexafluoropropylene copolymer (FEP), and ethylene-tetrafluoroethylene copolymer (ETFE), a polyester resin such as polyethylene terephthalate (PET), polyolefin resins such as polyethylene, polypropylene, and ethylene-vinyl acetate copolymer (EVA), a polyvinyl chloride resin (PVC) and a polymethylpentene resin, or the like can be used. The resin material contained in the insulator may be crosslinked or may be non-crosslinked.

The insulator 12 may be formed only of the resin material, or the insulator 12 may contain one or more additives selected from a flame retardant, a flame retardant aid, an antioxidant, a lubricant, a colorant, a reflection imparting agent, a masking agent, a processing stabilizer, a plasticizer, and the like, in addition to the resin material.

### 1-3 First Shield Layer

The coaxial cable 10 of the present embodiment may include the first shield layer 13. The first shield layer 13 may include a metal foil disposed spirally or longitudinally along a longitudinal direction of the insulator 12.

As shown in FIG. 2, in a conventional coaxial cable 20, a shield in which a metal element wire 211 was arranged in a spirally wound structure was used as a shield layer 21. However, in the case of the shield having the spirally wound structure, current flows spirally along a longitudinal direction of the metal element wire 211, and a surface of the shield layer 21, such as a surface 21A facing the insulator 12, includes unevenness derived from the shape of the metal element wire 211. Thus, a distance between the conductor 11 and the shield layer 21 is not constant, which affects the insertion loss.

In contrast, since the coaxial cable 10 has the first shield layer 13 including the metal foil disposed spirally or longitudinally along the longitudinal direction of the insulator 12, current flows along the longitudinal direction of the coaxial cable 10. In addition, the unevenness of the surface of the first shield layer can be reduced, and the surface can be smoothed. Thus, a coaxial cable having excellent insertion loss can be obtained. In the present specification, “coaxial cable having excellent insertion loss” means a coaxial cable having a small absolute value of insertion loss.

“Longitudinally” means that the metal tape is disposed such that the longitudinal direction of the metal tape is along the longitudinal direction of the conductor 11 or the insulator 12, and the metal tape is wound such that the width of the metal tape is along an outer periphery of the insulator 12.

Examples of the material of the metal foil include one or more metal materials selected from copper, copper alloy, aluminum, aluminum alloy, and the like. The material of the metal foil may be copper. Soft copper may be used as the copper.

By using copper for the metal foil of the first shield layer 13, workability in manufacturing of the coaxial cable is improved, and the coaxial cable having excellent insertion loss can be obtained.

The metal foil may be formed of a single metal species, or may be formed by stacking metal layers of two or more metal species. In addition, a material other than metal, such as a protective film containing an organic material, may be disposed on a surface of the metal foil.

The metal foil may have an elongation at break of 5% or more.

By setting the elongation at break of the metal foil to 5% or more, occurrence of breakage of the metal foil is suppressed when the coaxial cable is manufactured, and productivity and yield can be improved. In addition, by setting the elongation at break of the metal foil to 5% or more, the first shield layer can be prevented from being damaged even when the coaxial cable is repeatedly bent.

The elongation at break of the metal foil can be selected, for example, depending on heat treatment conditions when the metal foil is manufactured.

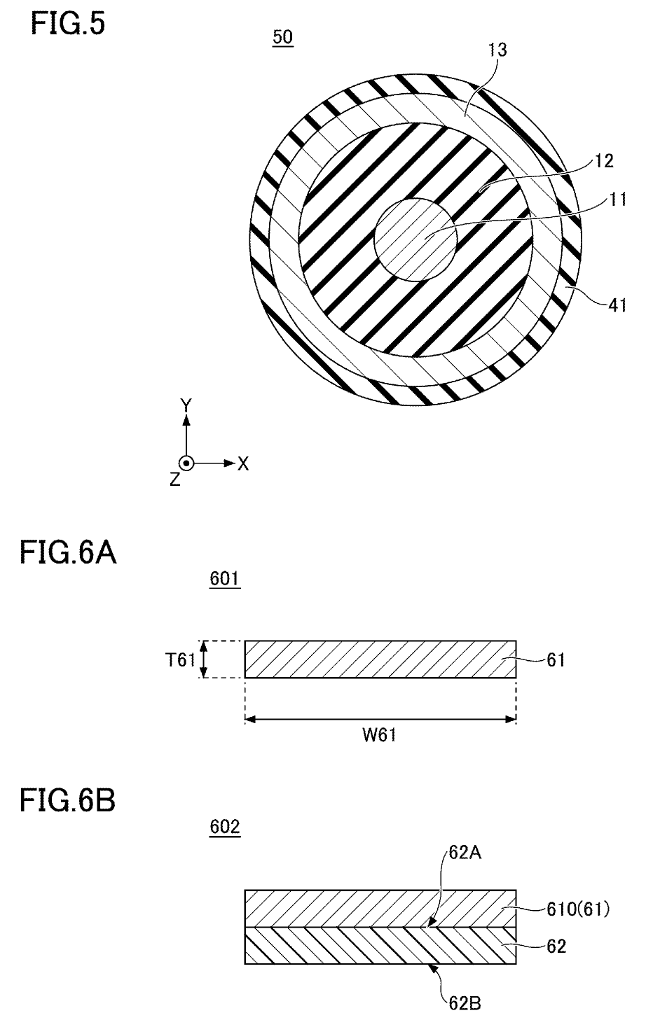

As shown in FIG. 6A, the first shield layer 13 may be formed by disposing a metal tape 601, which consists only of a metal foil 61, spirally or longitudinally along the longitudinal direction of the insulator 12. In this case, the first shield layer 13 consists only of the metal foil.

By forming the first shield layer 13 only of the metal foil, the coaxial cable having particularly excellent insertion loss can be obtained. Here, "the first shield layer consists only of the metal foil" means that the first shield layer is formed only of the metal foil without including a resin layer or an adhesive layer.

A width W61 of the metal foil 61 may be 2.0 mm to 6.0 mm, or may be 2.0 mm to 4.0 mm. By setting the width W61 of the metal foil 61 to 2.0 mm or more, in the case where the metal tape is disposed spirally, the number of times of winding the metal tape around the insulator 12 can be reduced when the first shield layer 13 is formed, and productivity can be improved. Further, by setting the width W61 of the metal foil 61 to be 2.0 mm or more, the entire outer periphery of the insulator 12 can be covered when the metal tape is disposed longitudinally. By setting the width W61 of the metal foil 61 to be 6.0 mm or less, handleability of the metal foil 61 is improved, and productivity at the time of forming the first shield layer 13 is improved.

A thickness T61 of the metal foil 61 may be 6 μm to 30 μm. By setting the thickness T61 of the metal foil 61 to 6 μm or more, the first shield layer 13 is prevented from being damaged, and shielding characteristics are improved. By setting the thickness T61 of the metal foil 61 to 30 μm or less, the handleability of the metal foil 61 is improved, and the productivity at the time of forming the first shield layer 13 is improved.

The first shield layer 13 may be formed by spirally winding the metal tape 601 along the longitudinal direction of the insulator 12 such that some portions of the metal tape 601 overlap each other. An overlap width, which is the width of the portion at which the metal tape 601 overlaps, may be, for example, 1/5 to 1/2 of the width W61 of the metal tape 601. By setting the overlap width of the metal tape 601 to be 1/5 or more of the width W61 of the metal tape 601, the first shield layer 13 can be formed without a gap outside the insulator 12. By setting the overlap width of the metal tape 601 to be 1/2 or less of the width W61 of the metal tape 601, smoothness of an outer surface of the first shield layer 13 can be improved.

The metal tape 601 may be disposed longitudinally along the outer periphery of the insulator 12 such that some portions of metal tape overlap each other. The overlap width of the metal tape in this case may be, for example, 1/5 to 1/2 of the width W61 of the metal tape 601.

The overlap width of the metal tape 601 may be constant in the coaxial cable 10, or may vary within a predetermined range.

### (2) Optional Members of Coaxial Cable

The coaxial cable of the present embodiment may further include optional members as necessary.

### 2-1 Second Shield Layer

The coaxial cable of the present embodiment may include a second shield layer 31 outside the first shield layer 13 as shown in FIG. 3. The second shield layer 31 includes a base-material-attached metal tape having a base material spirally disposed along the longitudinal direction of the insulator 12 and a metal layer disposed on the base material.

A coaxial cable 30 of the present embodiment further includes the second shield layer 31, and thus it is possible to particularly reduce signal leakage to the outside and radio wave intrusion from the outside, and to improve noise characteristics.

As shown in FIG. 6B, a base-material-attached metal tape 602 may include a base material 62 and a metal layer 610 stacked on the base material 62. The metal layer 610 of the base-material-attached metal tape 602 may be the metal foil 61.

Although FIG. 6B shows an example in which the metal layer 610 is disposed only on a first surface 62A of the base material 62, the metal layer 610 may also be disposed on a second surface 62B located opposite to the first surface 62A.

The base material 62 may contain a resin. Examples of the resin contained in the base material 62 include one or more resins selected from polyester resins such as polyethylene terephthalate (PET), polyolefin resins such as polypropylene (PP), and vinyl resins such as polyvinyl chloride resin (PVC). The base material 62 may contain additives and the like in addition to various resins.

Examples of the material of the metal layer 610 include one or more metal materials selected from copper, copper alloy, aluminum, aluminum alloy, and the like. The material of the metal layer may be copper. Soft copper may be used as the copper. The metal layer 610 may be formed of a single metal species, or may be formed by stacking metal layers of two or more metal species. In addition, a material other than metal, such as a protective film containing an organic material, may be disposed on the surface of the metal layer 610.

The metal layer 610 may be a vapor deposition film or a plating film.

### 2-2 Outer Sheath

The coaxial cable of the present embodiment may have an outer sheath 41 outside the second shield layer 31 as in a coaxial cable 40 shown in FIG. 4. Further, the coaxial cable of the present embodiment may include the outer sheath 41 outside the first shield layer 13 as in a coaxial cable 50 shown in FIG. 5.

The outer sheath 41 may be disposed at a position farthest from the conductor 11 in a cross-section perpendicular to the longitudinal direction of the coaxial cable, and may include an outer surface of the coaxial cable.

Since the coaxial cable of the present embodiment further includes the outer sheath 41, the inside members surrounded by the outer sheath 41 can be protected, and durability of the coaxial cable can be improved.

The outer sheath 41 may be disposed outside the first shield layer 13.

The method of forming the outer sheath 41 is not particularly limited, and can be selected according to the material of the outer sheath 41 and the like. For example, the outer sheath 41 may be formed by spirally disposing a resin tape including a resin material outside the first shield layer 13 or outside the second shield layer 31 along the longitudinal direction of the coaxial cable. The outer sheath 41 may be formed outside the first shield layer 13 or outside the second shield layer 31 by extrusion molding or the like.

The outer sheath 41 may include, for example, a resin material. Examples of the resin material include one or more resins selected from polyester resins such as polyethylene terephthalate (PET), fluororesins such as FEP or PFA, polyolefin resins such as polyethylene, and a polyvinyl chloride resin (PVC). The outer sheath 41 may include one or more materials selected from a polyester resin, a fluororesin, and a polyolefin resin.

The outer sheath 41 includes one or more materials selected from a polyester resin, a fluororesin, and a polyolefin resin, and thus flexibility and durability of the coaxial cable can be improved.

The outer sheath 41 may contain various additives such as a flame retardant in addition to the resin material.

The resin material of the outer sheath 41 may be crosslinked or may be non-crosslinked.

### Multicore Cable

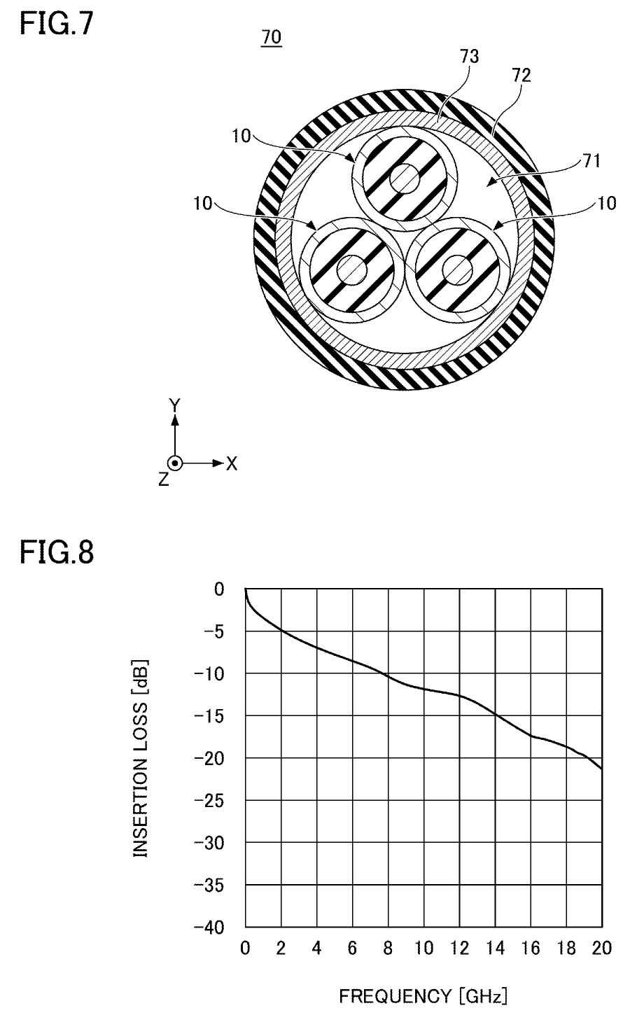

A cross-sectional view of a multicore cable 70 in a plane perpendicular to a longitudinal direction according to the present embodiment is shown in FIG. 7.

As shown in FIG. 7, the multicore cable 70 of the present embodiment includes a core 71 formed by twisting a plurality of coaxial cables 10, and a sheath 72 disposed outside the core 71. The core 71 may include the coaxial cable 10 according to an aspect of the present disclosure.

According to the multicore cable 70 of the present embodiment, since the coaxial cable 10 according to one aspect of the present disclosure is included, the multicore cable having excellent insertion loss can be obtained.

Although FIG. 7 shows an example in which the core 71 includes three coaxial cables 10 having the same structure, the number of the coaxial cables 10 included in the core 71 may be two, or may be four or more. The multicore cable may include coaxial cables having different structures and sizes. The multicore cable may include a drain wire, a coated electric wire not including a shield layer, or the like, in addition to the coaxial cable.

Members other than the coaxial cable included in the multicore cable of the present embodiment will be described.

### (1) Sheath

The sheath 72 may be disposed outside the core 71.

The sheath 72 may include a resin material. Examples of the resin material include one or more resins selected from polyolefin resins such as polyethylene, a polyvinyl chloride resin (PVC), thermoplastic elastomer (TPE), and the like.

The sheath 72 may contain various additives such as a flame retardant in addition to the resin material.

The resin material of the sheath 72 may be crosslinked or may be non-crosslinked.

The multicore cable 70 includes the sheath 72, and thus the coaxial cable 10 and the like disposed therein can be protected.

### (2) Outer Shield Layer

The multicore cable 70 may include an outer shield layer 73 between the core 71 and the sheath 72. The outer shield layer 73 may be disposed between the core 71 and the sheath 72.

Since the multicore cable 70 includes the outer shield layer 73, it is possible to particularly reduce signal leakage to the outside and radio wave intrusion from the outside, and to improve noise characteristics.

The outer shield layer 73 may include a conductive material.

For example, the outer shield layer 73 may be formed by spirally disposing a metal tape including a metal layer along a longitudinal direction of the core 71.

The outer shield layer 73 may include a metal element wire. In this case, the outer shield layer 73 may include the metal element wire having a spirally wound structure or a braided structure. Examples of the material of the metal element wire include one or more materials selected from copper, copper alloy, aluminum, aluminum alloy, and the like. The metal element wire may be plated with silver or tin on a surface thereof. Thus, as the metal element wire, for example, a silver-plated copper alloy, a tin-plated copper alloy, or the like can be used.

The outer shield layer 73 may have a plurality of layers instead of a single layer. When the outer shield layer 73 has a plurality of layers, for example, the outer shield layer 73 may have a first outer shield layer in which a base-material-attached metal tape is spirally wound along the longitudinal direction of the core 71, and a second outer shield layer in which a metal element wire has a spirally wound structure or a braided structure.

### (3) Wrapping Tape

The multicore cable 70 may have a wrapping tape that covers an outer surface of the core 71.

Since the multicore cable 70 has the wrapping tape, arrangement of a plurality of coaxial cables included in the multicore cable 70 can be stabilized and the plurality of coaxial cables are bundled.

As the wrapping tape, for example, a resin tape can be used.

Examples of the resin used for the resin tape include one or more resins selected from fluororesins such as a polytetrafluoroethylene (PTFE) resin or the like, polyester resins such as a polyethylene terephthalate (PET) resin or the like, polyethylene (PE), or the like, which exhibit excellent heat resistance, excellent abrasion resistance, or the like.

The resin tape used as the wrapping tape may contain a conductive substance such as carbon so that the resin tape has conductivity. The conductive substance may be added to the resin contained in the resin tape so as to be dispersed therein. Alternatively, for example, a metal tape in which a copper foil or an aluminum foil is disposed on a surface of the resin tape may be used.

### (4) Filler

The multicore cable 70 may also have a filler. The filler can be disposed in a gap between cables such as the coaxial cables 10.

The filler may include fibers such as staple yarns, nylon yarns, or the like. The filler may also include high-tensile fibers having a high tensile strength.

Since the multicore cable 70 has the filler, workability in manufacturing the core 71 and the multicore cable 70 can be improved. In addition, since the multicore cable 70 has the filler, the outer shape of the core 71 or the multicore cable 70 in the cross-section perpendicular to the longitudinal direction can easily be made an approximately circular shape, and handleability of the multicore cable 70 can be improved.

### EXAMPLES

The present disclosure will be described below with reference to specific examples, but the present invention is not limited to these examples.

### (1) Experimental Example 1

Coaxial cables of the following experimental example 1-1, experimental example 1-2, and experimental example 1-3 were produced. Experimental example 1-1 is an example, and experimental example 1-2 and experimental example 1-3 are comparative examples.

### Experimental Example 1-1

A coaxial cable having the cross-sectional structure shown in FIG. 1 was manufactured and evaluated.

That is, the coaxial cable 10 including the conductor 11, the insulator 12 disposed outside the conductor 11, and the first shield layer 13 disposed outside the insulator 12 was manufactured.

The first shield layer 13 was formed by spirally winding the metal tape 601 consisting only of a copper metal foil, with the thickness T61 of 9 μm and the width W61 of 3 mm, along the longitudinal direction of the insulator 12. The overlap width of the metal tape 601 was set to 1/4 of the width W61 of the metal tape 601.

Frequency dependency of insertion loss of the obtained coaxial cable was measured. In the measurement of the frequency dependency of insertion loss, the length of the obtained coaxial cable was set to 1 m. Then, in a shield room, the coaxial cable to be evaluated was placed in a straight line. A network analyzer was connected to the ends of the coaxial cable, and the S parameter (S21) was measured by sweeping a signal. The evaluation was performed in the atmosphere at room temperature. The evaluation result is shown in FIG. 8.

### Experimental Example 1-2

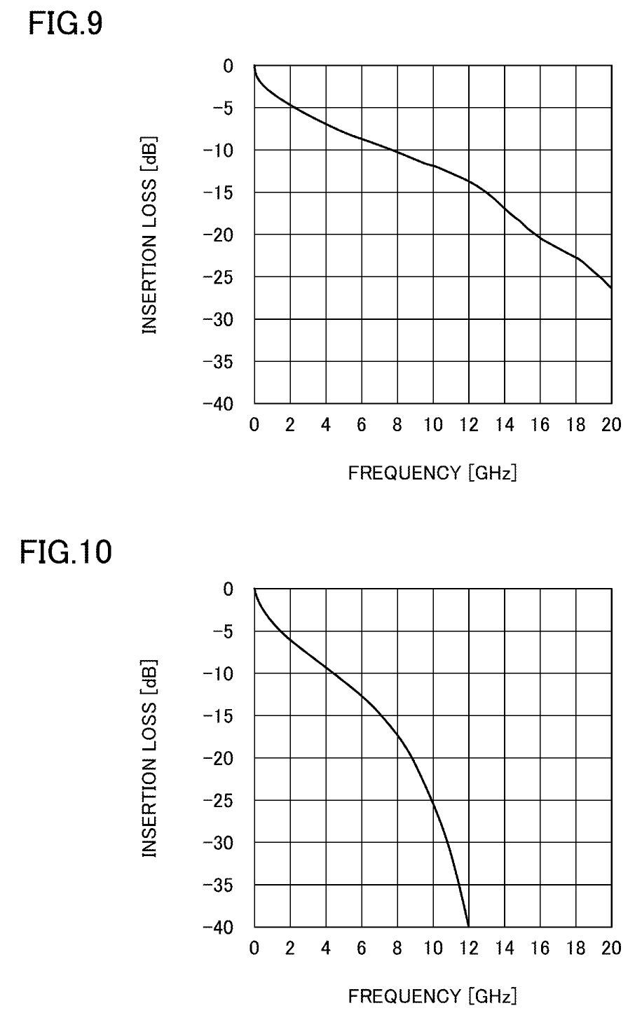

A coaxial cable was manufactured and evaluated under the same conditions as in experimental example 1-1 except that the metal element wire has a spirally wound structure in the first shield layer. That is, a coaxial cable having the cross-sectional structure shown in FIG. 2 was manufactured. The evaluation result is shown in FIG. 9.

### Experimental Example 1-3

A coaxial cable was manufactured and evaluated under the same conditions as in experimental example 1-1 except that the first shield layer was formed of the base-material-attached metal tape shown in FIG. 6B instead of the metal foil. As the base-material-attached metal tape, a tape in which the metal layer 610 made of copper was stacked only on the first surface 62A of the base material 62 made of polyethylene terephthalate was used. The thickness and width of the metal layer 610 were the same as those of the metal tape of the experimental example 1-1. The evaluation result is shown in FIG. 10.

As is clear from the comparison of FIGS. 8, 9, and 10, it was confirmed that the insertion loss of the coaxial cable of experimental example 1-1 was improved when compared with the coaxial cables of experimental examples 1-2 and 1-3 in a band of frequencies higher than 10 GHz, for example, at 20 GHz. That is, it was confirmed that the coaxial cable of experimental example 1-1 was a coaxial cable having excellent insertion loss.

### (2) EXPERIMENTAL EXAMPLE 2

The following coaxial cables of experimental example 2-1, experimental example 2-2, experimental example 2-3, experimental example 2-4, experimental example 2-5, and experimental example 2-6 were produced, and the number of times (the number of cables) the metal tape used for the first shield layer 13 was wound without being cut was evaluated.

All of experimental example 2-1 to experimental example 2-6 are examples.

### Experimental Example 2-1

A coaxial cable having the cross-sectional structure shown in FIG. 1 was manufactured and evaluated.

That is, the coaxial cable 10 including the conductor 11, the insulator 12 disposed outside the conductor 11, and the first shield layer 13 disposed outside the insulator 12 was manufactured.

The first shield layer 13 was formed by spirally winding the metal tape 601 consisting only of a copper metal foil, with the thickness T61 of 9 μm and the width W61 of 3 mm, along the longitudinal direction of the insulator 12. The overlap width of the metal tape 601 was set to 1/4 of the width W61 of the metal tape 601.

The elongation at break of the metal tape used in the manufacture of the coaxial cable was 2%. The elongation at break corresponds to the total elongation at break measured in accordance with JIS Z 2241 (2022).

Ten coaxial cables were manufactured under the same conditions, and the number of times a 50 m coaxial cable could be manufactured without breaking the metal tape during the manufacture of the first shield layer 13 was determined and taken as the number of successes.

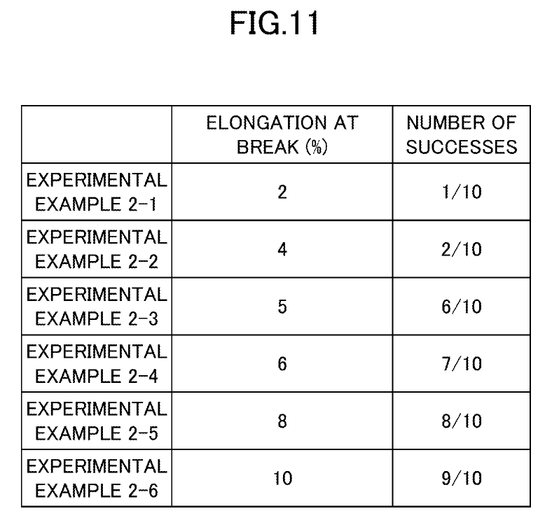

The evaluation result is shown in FIG. 11.

### Experimental Example 2-2 to Experimental Example 2-6

Coaxial cables were manufactured and evaluated under the same conditions as in experimental example 2-1 except that the heat treatment time in manufacturing the metal tape 601 was changed and the elongations at break were the values shown in FIG. 11.

The evaluation results are shown in FIG. 11.

According to the results shown in FIG. 11, it was confirmed that the number of successes (the number of successful cables) increased with an increase in the elongation at break. In particular, it was confirmed that, when the elongation at break was 5% or more, the number of successes was significantly increased as compared with experimental examples 2-1 and 2-2 in which the elongation at break was less than 5%.

What is claimed is:

1. A coaxial cable comprising:
a conductor;
an insulator disposed outside the conductor; and
a first shield layer disposed outside the insulator,
wherein the first shield layer includes a metal foil disposed spirally or longitudinally along a longitudinal direction of the insulator.

2. The coaxial cable according to claim 1,
wherein the metal foil has an elongation at break of 5% or more.

3. The coaxial cable according to claim 1,
wherein the first shield layer consists only of the metal foil.

4. The coaxial cable according to claim 1,
wherein the metal foil includes copper.

5. The coaxial cable according to claim 1, further comprising:
a second shield layer outside the first shield layer,
wherein the second shield layer includes a metal tape with a base material, the metal tape including the base material and a metal layer disposed on the base material, and the metal tape being disposed spirally along the longitudinal direction of the insulator.

6. The coaxial cable according to claim 5, further comprising:
an outer sheath outside the second shield layer.

7. The coaxial cable according to claim 1, further comprising:
an outer sheath outside the first shield layer.

8. The coaxial cable according to claim 6,
wherein the outer sheath includes one or more materials selected from a polyester resin, a fluororesin, and a polyolefin resin.

9. A multicore cable comprising:
a core formed by twisting a plurality of coaxial cables; and
a sheath disposed outside the core
wherein the plurality of coaxial cables include at least one coaxial cable of claim 1.

10. The multicore cable according to claim 9, further comprising:
an outer shield layer between the core and the sheath.
